(19) United States
(12) Patent Application Publication
(10) Pub. No.: US 2015/0000118 A1
(43) Pub. Date: Jan. 1, 2015

(54) METHOD FOR MANUFACTURING GRAPHENE-INCORPORATED RECHARGEABLE LI-ION BATTERY

(71) Applicants: XIN ZHAO, New York, NY (US); Minjie Li, New York, NY (US)

(72) Inventors: XIN ZHAO, New York, NY (US); Minjie Li, New York, NY (US)

(21) Appl. No.: 13/927,125

(22) Filed: Jun. 26, 2013

(51) Int. Cl. H01M 10/04

(52) U.S. Cl. CPC H01M 10/04
USPC 29/623.3; 29/623.1; 29/623.5

(57) ABSTRACT

A method for manufacturing a graphene-incorporated rechargeable Li-ion battery discloses a graphene-incorporated rechargeable Li-ion battery with enhanced energy and power delivery abilities. The method comprises the steps (a) fabricating a high-performance anode film based on graphene or graphene hybrid; (b) introducing a desired amount of lithium into the anode material to produce a prelithiated graphene-based anode; (c) constructing a full cell utilizing a cathode film and the prelithiated anode film. The graphene-based anodes incorporating exfoliated graphene layers overcome the large irreversible capacity and initial lithium ion consumption upon pre-lithiation, and demonstrate remarkably enhanced specific capacity and rate capability over conventional anodes.

### FIELD OF THE INVENTION

The present invention relates to Li-ion batteries, and in particular to a method for manufacturing a graphene-incorporated rechargeable Li-ion battery

### BACKGROUND OF THE INVENTION

Safety concerns over utilization of pure metallic lithium foils as negative electrodes for rechargeable lithium-ion batteries have led to the development of carbonaceous materials as alternative anode. Conventional Li-ion batteries comprise a primary graphite as a carbonaceous anode in conjunction with a lithium-containing metal oxide, for example, lithium cobalt oxide (LiCoO2) and lithium manganese oxide (LiMn2O4) as a cathode. Upon ideal charge/discharge reactions, lithium ions are intercalated and de-intercalated between the stacked graphene layers reversibly, yielding 100% charge/discharge efficiency. The resulting graphitic compound intercalated with lithium ions may be expressed as LixC6, where x is typically less than 1 for well-ordered graphite without significant turbostratic disordering. This corresponds to a theoretical specific capacity of 372 mAh/g (x=1, e.g. LiC6). In order to minimize capacity reduction due to this replacement, x in LixC6 must be maximized, and the irreversible capacity loss due to side reactions in the initial cycles must be minimized.

Graphene is considered a promising electrode material toward Li-ion batteries with high power and energy delivery, attributed to its high conductivity and high surface area without pore tortuosity. The large specific surface area, abundant edge planes and defects of graphene, as well as microcavities and pores present between rearranged graphene crystallites provide excess Li ion binding and storage sites compared with conventional graphitic anodes (see FIGS. 1A and 1B). FIGS. 1A and 1B show a structural model of an ordered graphitic carbon (1A) and a disordered graphene stacks (1B). Pronounced improvement of reversible capacity has therefore been demonstrated in graphene anode, and very large reversible capacity up to 740 mAh/g (composition of LiC3) can be envisioned. Besides, lithium intercalation into graphene is not limited by the kinetics of lithium staging reactions within conventional graphitic anodes. The high Li ion diffusivity and electrical conductivity greatly accelerates the kinetics of charge-transfer and diffusion reactions of graphene anode, which can therefore operate at very high charge/discharge rates while retaining a high capacity.

However, irreversible reactions usually occur intensively in graphene anode when contacting with electrolyte. This is caused by the large surface area of irregular plates and direct exposure of highly active edge planes of graphene layers. The irreversible consumption of Li ions in the initial cycles leads to deficiency of Li ions in the battery cell and destruction of original anode structures, and subsequent capacity fading is evitable. To suppress the irreversible reactions of Li ions with carbonaceous materials, the carbonaceous particles are usually subjected to grinding and reassembly to obtain a smooth surface, or high-temperature graphitization processes to eliminate structural disordering. Further irreversible reactions associated with edge planes can be reduced by coating the particles to prevent direct exposure to electrolyte. Nevertheless, these processes kill the intrinsic advantageous features of graphene anode such as high specific surface area and Li ion diffusivity, which sacrifices the reversible capacity and rate capability of graphene anode.

Another common practice to address this issue is to load excess cathode material when assembling Li-ion batteries, so that the loss of Li ions during the initial cycles can be compensated by the excess Li ions introduced by cathode. However, such method results in a battery cell having cathode and anode which are stoichiometrically unbalanced. The excess cathode material adds the weight and cost of the cell, and may lead to internal shorts, combustible gas generation and thus catastrophic failure if the excess lithium is deposited non-uniformly on the anode or isolated from both electrodes (Referring to G. -A. Nazri and B. J. Howie, Method for Manufacturing Lithium-Deactivated Carbon Anodes, European Patent EP 96201589.7.).

### SUMMARY OF THE INVENTION

Accordingly, the object of the present invention is to provide a method for manufacturing a graphene-incorporated rechargeable Li-ion battery, wherein the battery has enhanced power supply ability and quick delivery of the charges. Therefore the invention describes a design of graphene-incorporated rechargeable Li-ion batteries and overcomes the aforementioned problems by prelithiating the graphene-based electrodes.

The battery cell contains a graphene-incorporated anode preloaded with appropriate amount of lithium, which is positioned opposite a cathode. The anode and cathode is physically separated by a non-aqueous ionic conductor in liquid, solid or gel format.

The approach of the present invention comprises (a) fabricating a high-performance anode film based on graphene or graphene hybrid; (b) introducing a desired amount of lithium into the anode film to produce a prelithiated graphene-based anode film; (c) constructing a full cell utilizing a cathode film and the prelithiated graphene-based anode film. The graphene-based anodes incorporating pristine or functionalized graphene layers demonstrate remarkably enhanced specific capacity and rate capability over conventional graphitic anode (referring to FIG. 3), offering possibilities to achieve unprecedented combinations of energy and power output for high-performance Li-ion batteries. Lithiating the graphene-based anodes prior to battery cell assembly eliminates the Li ion consumption associated with the irreversible reactions of graphene efficiently, and the cells attain improved electrode utilization, capacity retention and cycling efficiency with minimized safety hazards during operation.

Lithiation of anode materials in a prior art Li-ion battery usually induces a large volumetric expansion to the active particles and electrode films, for example 300-400% of its original dimension of silicon particle or thin film (see Ref. 2). Such highly lithiated particles or films are extremely brittle and prone to pulverization or fragmentation during successive charge/discharge cycling. These two issues can be significantly mitigated by the incorporation of graphene in the anode formation. First, the small size and mechanical flexibility of graphene sheets can readily accommodate any Li ion insertion/extraction stress and volume variation, representing a highly stable lithium-retentive anode system that can be coupled with lithium-free cathode materials to construct full battery cells (Ref. 3). Such graphene-based anodes with superb tolerance to structural deformation also provide a robust matrix to support or incorporate other high-capacity active species such as metal and intermetallic alloys, which could lead to a variety of high-performance composite anodes. The mechanical integrity of such anodes is consequently preserved after lithiation.

### BRIEF DESCRIPTION OF THE DRAWINGS:

FIG. 1A shows a structural model of an ordered graphitic carbon (left).

FIG. 1B shows a structural model of a disordered graphene stacks (right).

FIG. 2 shows a Li-ion battery with a cathode and a prelithiated graphene-based anode immersed in an electrolyte and isolated by a polymer separator.

FIG. 3 shows a preparation procedure of prelithiated graphene nanoplatelet-based anode.

FIG. 4 shows a specific capacity and coulombic efficiency of graphene nanoplatelet-based anodes at various current densities in comparison with conventional graphitic anode.

FIG. 5 shows the charge/discharge curves of graphene nanoplatelet-based anodes in comparison with conventional graphitic anode.

FIG. 6 shows the discharge capacity and coulombic efficiency of Li-ion batteries with NMC cathode and graphene nanoplatelet-based anodes. The 1st cycle coulombic efficiency of cells with prelithiated graphene anode is 91% compared to 32% for non-lithiated anode.

FIG. 7 shows the Charge/discharge curves of Li-ion batteries with NMC cathode and graphene nanoplatelet-based anodes.

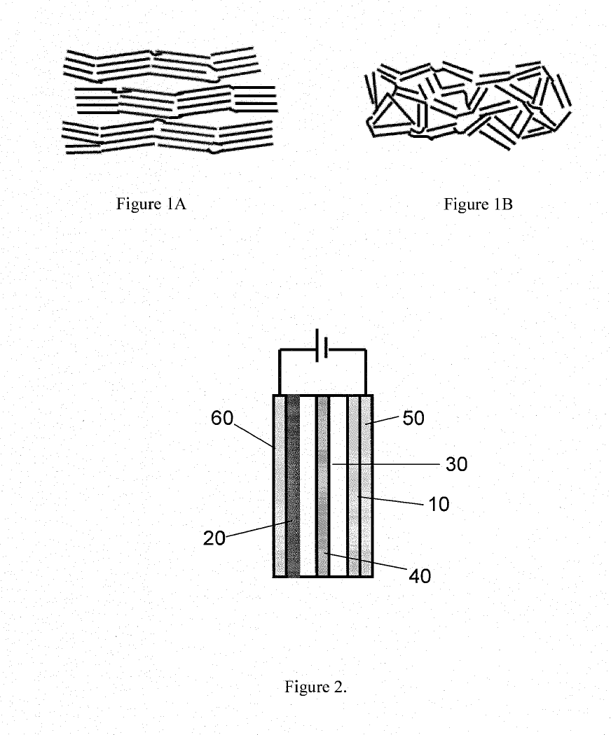

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

The present invention describes a design of graphene-incorporated rechargeable Li-ion batteries and overcomes the aforementioned problems by prelithiating the graphene-based electrodes. The battery cell contains a graphene-incorporated anode 10 preloaded with appropriate amount of lithium, which is positioned opposite a cathode 20 (see FIG. 2). The anode and cathode is physically separated by a non-aqueous ionic conductor 30 in liquid, solid or gel format. FIG. 2 shows a Li-ion battery with a cathode 20 and a prelithiated graphene-based anode 10 immersed in an electrolyte 30 and isolated by a polymer separator 40. A layer of anode current collector 50 is arranged at an outer side of the anode 10 for collecting current generating from the electrode 10, and a layer of cathode current collector 60 is arranged at an outer side of the cathode 20 for collecting current generating from the electrode 20.

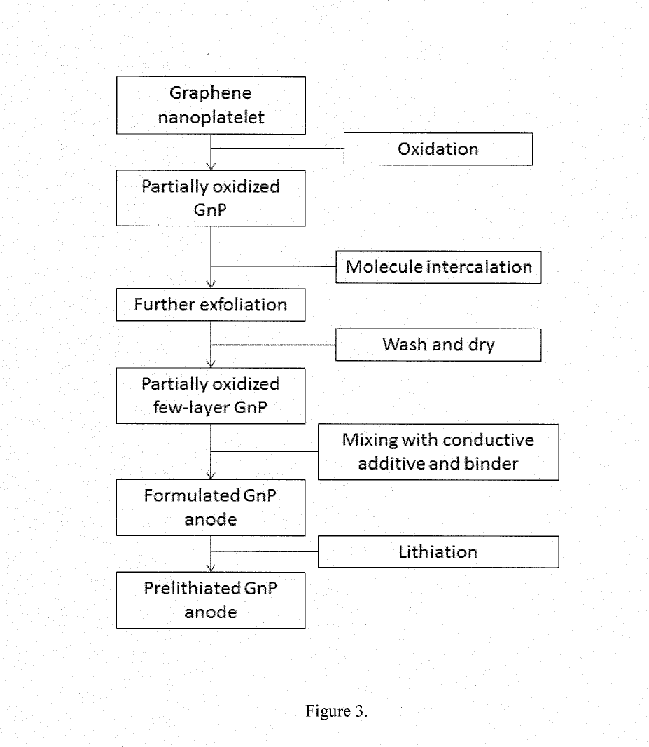

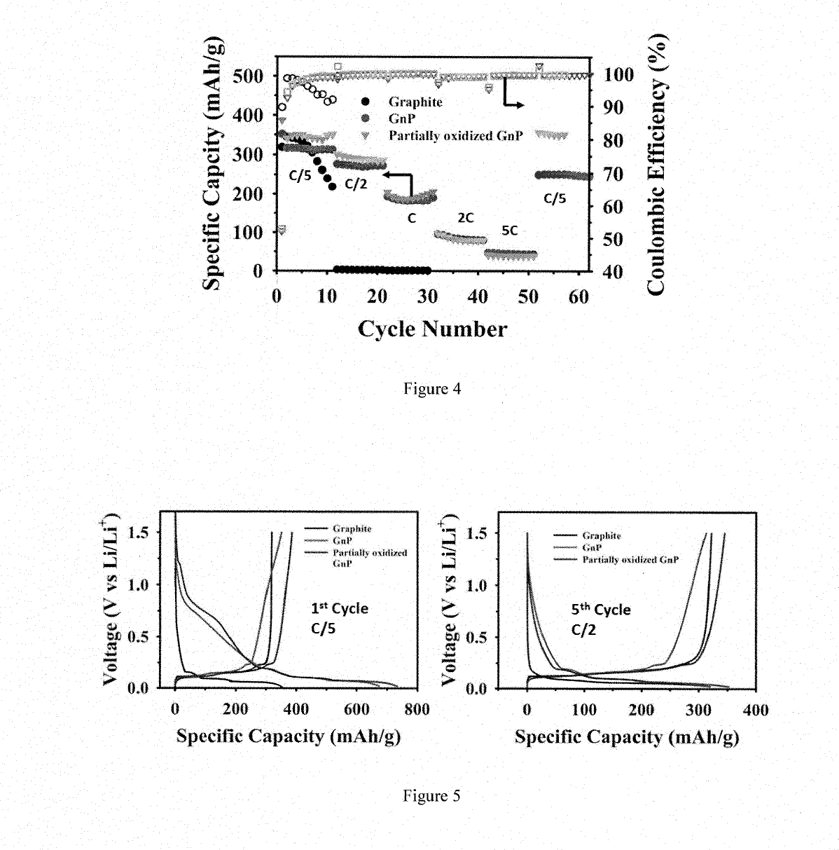

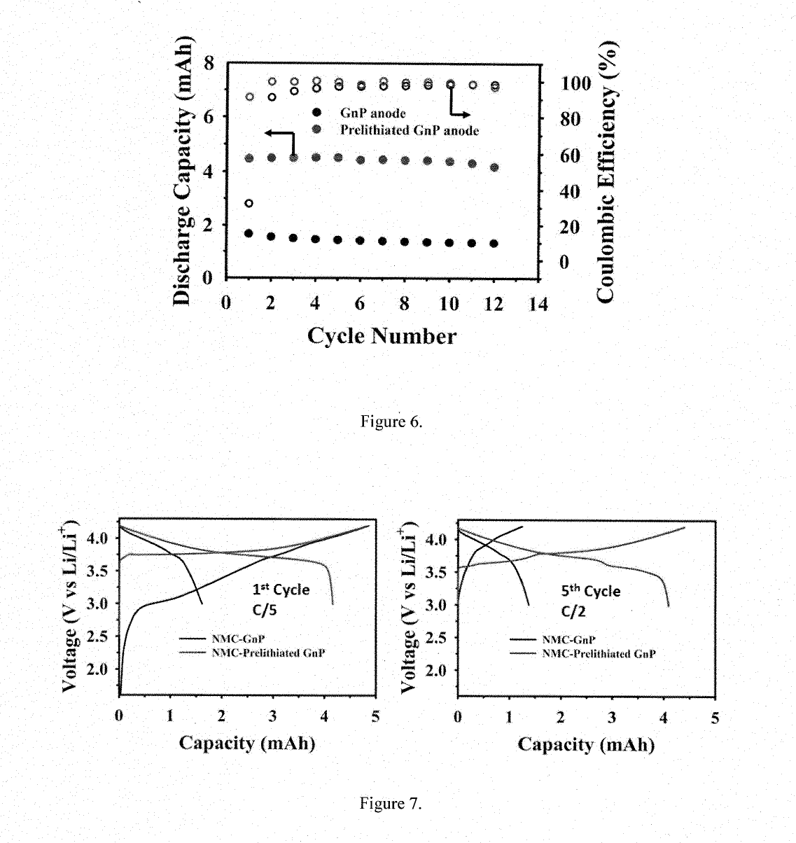

The approach of the present invention comprises (a) fabricating a high-performance anode film based on graphene or graphene hybrid; (b) introducing a desired amount of lithium into the anode film to produce a prelithiated graphene-based anode film; (c) constructing a full cell utilizing a cathode film and the prelithiated graphene-based anode film. The graphene-based anodes incorporating pristine or functionalized graphene layers demonstrate remarkably enhanced specific capacity and rate capability over conventional graphitic anode (referring to FIG. 3). FIG. 3 shows a preparation procedure of prelithiated graphene nanoplatelet-based anode.), offering possibilities to achieve unprecedented combinations of energy and power output for high-performance Li-ion batteries. Lithiating the graphene-based anodes prior to battery cell assembly eliminates the Li ion consumption associated with the irreversible reactions of graphene efficiently, and the cells attain improved electrode utilization, capacity retention and cycling efficiency with minimized safety hazards during operation (as illustrated in FIG. 4). FIG. 4 shows a specific capacity and coulombic efficiency of graphene nanoplatelet-based anodes at various current densities in comparison with conventional graphitic anode.

Lithiation of anode materials in a prior art Li-ion battery usually induces a large volumetric expansion to the active particles and electrode films, for example 300-400% of its original dimension of silicon particle or thin film (see A. Zhamu and B. Z. Jang, Method of Producing Prelithiated Anodes for Secondary Lithium Ion Batteries, U.S. patent application Ser. No. 12/291,689.) Such highly lithiated particles or films are extremely brittle and prone to pulverization or fragmentation during successive charge/discharge cycling.

The small size and mechanical flexibility of graphene sheets can readily accommodate any Li ion insertion/extraction stress and volume variation, representing a highly stable lithium-retentive anode system that can be coupled with lithium-free cathode materials to construct full battery cells (Referring to N. Liu, L. Hu, M. T. McDowell, A. Jackson and Y. Cui, Prelithiated Silicon Nanowires as an Anode for Lithium Ion Batteries, ACS Nano, 5 (2011), 6487-6493.). Such graphene-based anodes with superb tolerance to structural deformation also provide a robust matrix to support or incorporate other high-capacity active species such as metal and intermetallic alloys, which could lead to a variety of high-performance composite anodes.

To fabricate a graphene-based anode, graphene nanoplatelets (GnP), functionalized graphene, reduced graphene oxide etc. is mixed with a polymer binder and a conductive additive such as carbon black, carbon nanotubes (CNTs) or carbon nanofibers (CNFs). The mixture is deposited onto current collectors by tape casting, spin coating, dip coating or lamination etc. The binders include at least one of polyvinylidene fluoride (PVDF), copolymers of PVDF e.g. poly(vinylidene fluoride-co-hexa fluoropropylene) (PVDF-HFP), polyvinyl chloride (PVC), polyethylene (PE), polypropylene (PP), ethylene vinyl acetate, polyvinyl alcohol (PVA), and celluloses e.g. methyl cellulose, carboxymethyl cellulose, ethyl cellulose, butyl cellulose cellulose acetate and cellulose nitrate. Other electrochemically active species can be introduced to graphene to form a hybrid active material. These materials can be metals e.g. silicon, germanium and tin, redox-based transition metal oxides e.g. tin oxide (SnO and SnO2), iron oxide (FexOy) and cobalt oxide (CoO and Co3O4), and electrically conducting polymers.

The cathode film is a blend of a conductive additive e.g. graphite flakes, CNTs, CNFs or graphene, a polymer binder and an active material such as intercalation materials e.g. LiCoO2, LiMn2O4, lithium nickel oxide (LiNiO2), lithium iron phosphate (LiFePO4), manganese oxide (MnO2), vanadium oxide (V2O5) and molybdenum oxide (MoO3), or sulfur, or active organics e.g. electrically conducting polymers and oxocarbon salts.

The electrolyte is a non-aqueous solution containing one or a few types of carbonates e.g. ethylene carbonate (EC), propylene carbonate (PC), dimethyl carbonate (DMC) and diethyl carbonate (DEC) etc., and a lithium salt e.g. LiPF6, LiClO4, LiTFSI, LiBOB, LiAlO2 and LiBF4.

Alternatively, the electrolyte can be a gel or solid film, which also acts as a separator. It consists of a polymer host e.g. PVDF, PVDF-HFP, poly(ethylene oxide) (PEO), poly(acrylonitrile) (PAN), and poly(methyl methacrylate) (PMMA) or an ionic liquid e.g. PYR14FSI, [BMIM]Cl and [EMIM]Cl, a lithium salt, and an optional plasticizer e.g. inorganic nanoparticles (SiO2, Al2O3 and MgO etc.), EC and PC to strengthen the ionic conductivity.

To prelithiate the anode film, one method is to disperse stabilized lithium metal powders in a non-polar solvent which is then deposited onto the top surface of the anode film uniformly via spray coating, drop casting or spin coating etc. Alternatively, the stabilized lithium metal powders can be mixed with the anode slurry during casting of anode films. These stabilized lithium metal powders are usually pre-coated with a stable protection layer and therefore safe to be handled in an environment without moisture. A powder product with metallic lithium content above 98% is commercially available from FMC Corporation. The amount of lithium is determined by the irreversible capacity of the anode film, which is sufficient to compensate the lost Li ions during the initial cycles.

Another method is to physically attach metallic lithium foils or ribbons to the top surface of the anode film in an inert atmosphere. An organic solvent e.g. DMC, PC or above liquid electrolyte is injected to the lithium/anode interface if necessary, which functions as a media to accelerate Li ion diffusion. The Li ions diffuse from the metallic lithium into the anode film spontaneously, and the residual lithium is removed by detaching from the anode surface. The lithiation depth of anode can be varied upon changing the lithiation time and monitored through the open circuit voltage of the cell. Typically 12-20 hour lithiation ensures a saturation of lithium percentage in the anode film.

Prelithiation can also be achieved galvanostatically by assembling the anode film into a half cell e.g. a coin cell, pouch cell or standard electrochemical cell containing a lithium counter electrode and electrolyte solution. The anode film undergoes a first cycle followed by lithiation to a cathodic voltage limit vs. Li, which determines the lithiation depth. The half cell is then taken apart and the lithiated anode film can be reassembled into a full cell.

### EXAMPLE

To prepare partially oxidized GnP (ox-GnP), referring to FIG. 3, commercial GnP nanoplatelets are immersed in an acid, e.g concentrated nitric acid or nitric acid and sulfuric acid mixture. An oxidant e.g. potassium chlorate or potassium bichromate are added into mixture under vigorous stirring. The reacted GnP is washed thoroughly and partially oxidized GnP intercalated with acid was obtained upon drying. The ox-GnP is then re-intercalated with tetrabutylammonium hydroxide (TBA) or oleyl amine solution in dimethylformamide (DMF) via stirring or solvothermal reaction at elevated temperature. After cooling down, the exfoliated ox-GnP is washed and re-dispersed in DMF or N-methyl-2-pyrrolidone (NMP). charge/discharge tests were done using a CR2032-type coin cell. Metallic lithium is used as the counter electrode. The working electrode is fabricated by first pasting a mixture of graphite or GnP flakes, carbon black and PVDF with a weight ratio of 82:8:10 onto supper foil. The typical mass loading level is about 1 mg per cm2 area of the electrode. The electrode was dried at 90° C. for 12 hour under vacuum before being assembled into a coin cell in an. Ar-filled glovebox. The electrolyte solution is 1 M LiPF6/ethylene carbonate (EC)/dimethyl carbonate (DMC) (1:1 by volume). A microporous glass-fiber membrane (Whatman) is used as the separator. Lithium insertion into the electrode is referred to as the discharge test , and extraction is referred to as the charge test.

To prelithiate the GnP electrode, the electrode film is directly attached to a lithium foil (0.38 mm thick, Sigma-Aldrich) with 1 M LiPF6/EC/DMC electrolyte between inside an Ar-filled glovebox. After 12 hours the electrode is peeled off from the Li foil and washed with acetonitrile to remove the residual electrolyte and lithium salt if necessary.

To assemble a full cell, the separator 40 is placed on the anode 10, and a lithium nickel manganese cobalt oxide (NMC) cathode 20 is stacked on top. The full cell is sealed inside an aluminum laminated pouch with metal current collectors 50, 60 extending out The electrolyte solution containing 1 M LiPF6/ethylene carbonate (EC)/dimethyl carbonate (DMC) (1:1 by volume) is injected into the pouch before sealing.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing a graphene-incorporated rechargeable Li-ion battery comprising the steps of
(a) fabricating a high-performance anode film based on graphene or graphene hybrid;
(b) introducing a predetermined amount of lithium into the anode film to produce a prelithiated graphene-based anode film;
(c) constructing a full cell utilizing a cathode film and the prelithiated graphene-based anode film; the cathode and anode is immersed in a liquid electrolyte and a separator is placed in the electrolyte for separating the anode and the cathode, alternatively, the electrolyte is one of a gel or solid films; and
wherein the graphene-based anodes incorporating exfoliated graphene layers overcome the large irreversible capacity and initial lithium ion consumption upon prelithiation, and demonstrate remarkably enhanced specific capacity and rate capability over conventional anodes.

2. The method of claim 1, wherein the step of introducing a predetermined amount of lithium comprising the steps of depositing stabilized lithium metal powders onto a top surface of the anode film uniformly via spray coating, drop casting or spin coating; wherein an amount of lithium is determined by an irreversible capacity of the anode film, which is sufficient to compensate lost Li ions during initial cycles;

3. The method of claim 1, wherein the step of introducing a predetermined amount of lithium comprising the steps of attaching metallic lithium foils or ribbons physically to a top surface of the anode film, and an organic solvent being injected to the lithium/anode interface; then the Li ions diffusing from the metallic lithium into the anode film spontaneously, and the residual lithium being removed by detaching from the anode surface;

4. The method of claim 1, wherein the step of introducing predetermined amount of lithium comprising the steps of assembling the anode film into a half cell with Li counter electrode and electrolyte, by galvanostatic cycling to a cathodic voltage limit vs. Li, which determines the lithiation depth; the half cell is then taken apart and the lithiated anode film can be reassembled into a full cell.

5. The method of claim 1, wherein for forming a graphene-based anode, graphene nanoplatelets (GnP), functionalized graphene, reduced graphene oxide and other predetermined materials are mixed with a polymer binder and a conductive additive; the mixture is deposited onto anode current collector and cathode current collector by tape casting, spin coating, dip coating or lamination.

6. The method of claim 1, wherein electrochemically active species are introduced to graphene to form a hybrid active material, which are selected from metals or metal oxides or electrically conducting polymers.

7. The method of claim 6, wherein the metal is one of silicon, germanium and tin.

8. The method of claim 6, wherein the metal oxide is at least one of redox-based transition metal oxides including tin oxide (SnO and SnO2), iron oxide (FexOy) and cobalt oxide (CoO and Co3O4).

9. The method of claim 5, wherein the conductive additive includes carbon black, carbon nanotubes (CNTs) and carbon nanofibers (CNFs)

10. The method of claim 5, wherein the polymer binder includes polyvinylidene fluoride (PVDF), copolymers of PVDF; poly(vinylidene fluoride-co-hexa fluoropropylene) (PVDF-HFP), polyvinyl chloride (PVC), polyethylene (PE), polypropylene (PP), ethylene vinyl acetate, polyvinyl alcohol (PVA), and celluloses.

11. The method of claim 10, wherein the cellulose is one of methyl cellulose, carboxymethyl cellulose, ethyl cellulose, butyl cellulose cellulose acetate and cellulose nitrate.

12. The method of claim 1, wherein the cathode film is a blend of a conductive additive and at least one of active materials including lithium metal phosphate (LiFePO4, LiMnPO4 etc.), manganese oxide (MnO2), vanadium oxide (V2O5) and molybdenum oxide (MoO3), sulfur, or active organic compounds.

13. The method of claim 1, wherein the electrolyte between the anode and cathode is a non-aqueous solution containing at least one of carbonates and a lithium salt.

14. The method of claim 13, wherein the carbonate includes ethylene carbonate (EC), propylene carbonate (PC), dimethyl carbonate (DMC) and diethyl carbonate (DEC).

15. The method of claim 13, wherein the lithium salt is one of LiPF6, LiClO4, LiTFSI, LiBOB, LiAlO2 and LiBF4.

16. The method of claim 1, wherein a separator is placed in the electrolyte for separating the anode and the cathode.

17. The method of claim 16, wherein the separator is one of a microporous polymer film such as PVDF, PVDF-HFP, poly(ethylene oxide) (PEO), poly(acrylonitrile) (PAN), and poly(methyl methacrylate) (PMMA).

18. The method of claim 1, wherein the electrolyte is one of an ionic liquid , a lithium salt, and an optional plasticizer such as EC and PC for strengthening the ionic conductivity.

19. The method of claim 18, wherein the ionic liquid is selected from PYR14FSI, [BMIM]Cl and [EMIM]Cl, and the optional plasticizer is selected from inorganic nanoparticles of SiO2, Al2O3 and MgO.
